(19) United States
(12) Patent Application Publication
(10) Pub. No.: US 2021/0269894 A1
(43) Pub. Date: Sep. 2, 2021

(54) METHOD OF RECOVERY OF NICKEL AND COBALT

(71) Applicant: PUKYONG NATIONAL UNIVERSITY INDUSTRY-UNIVERSITY COOPERATION FOUNDATION, Busan (KR)

(72) Inventor: Jei Pil WANG, Busan (KR)

(21) Appl. No.: 16/306,326

(22) PCT Filed: Nov. 20, 2018
(86) PCT No.: PCT/KR2018/014276

§ 371 Date: Nov. 30, 2018

(30) Foreign Application Priority Data
Nov. 13, 2018 (KR) 10-2018-0138609

(51) Int. Cl. C22B 23/02; H01M 10/54; B01J 6/00

(52) U.S. Cl. CPC C22B 23/021; B01J 6/00; H01M 10/54

(57) ABSTRACT

The present disclosure provides a method for recovering nickel and cobalt, the method comprising: a first step of heat-treating lithium nickel cobalt aluminum oxide to produce a mixture; a second step of water-washing the mixture produced in the first step to obtain a residue; and a third step of heat-treating the residue obtained in the second step.

### 1. FIELD

The present disclosure relates to a nickel and cobalt recovery method. More particularly, the present disclosure relates to a method for recovering nickel, cobalt and lithium carbonate from waste lithium nickel cobalt aluminum oxide (NCA).

### 2. DESCRIPTION OF RELATED ART

A lithium ion battery is a type of a secondary battery that may be recharged and reused, has a high energy density and no memory effect. When the lithium ion battery is not in use, a degree of a self-discharge of the lithium ion battery is small. Thus, the lithium ion battery is widely used for portable electronic devices in the market. In addition, a frequency of use of the battery is increasing in the fields of an industry including a military industry, an automation system, an electric vehicle industry, and an aviation industry due to the characteristics of the high energy density of the battery. Although such a lithium ion battery can be charged and discharged and has a relatively long lifespan, the life of the battery is in a range of about 6 months to 2 years. Accordingly, an amount of waste of the battery is also increased along with an increase in the amount of use of the battery.

The lithium-ion battery may be composed largely of an anode, a cathode, and an electrolyte, which may employ a wide variety of materials. In particular, the lithium-ion batteries may be classified into lithium nickel cobalt manganese oxide (NCM), lithium nickel cobalt aluminum oxide (NCA), lithium cobalt oxide (LCO), lithium manganese oxide (LMO) and lithium iron phosphate (LFP) batteries depending on a cathode active material which accounts for 35% of the lithium ion battery material. The NCM battery contains a ternary alloy material of nickel (Ni), cobalt (Co) and manganese (Mn) as a cathode material. The NCA battery contains, as a cathode material, a ternary alloy material of nickel (Ni), cobalt (Co), and aluminum (Al). The LCO battery contains lithium (Li) and a cobalt (Co) oxide as a cathode material.

The lithium is a rare metal and the lithium reserves are insufficient. As demand for the lithium-ion batteries grows, a possibility of lithium depletion continues to rise. Further, waste Lithium ion batteries contain a large amount of environmentally hazardous substances that are difficult to be simply disposed. Thus, recycling of the waste lithium ion batteries may prevent environmental pollution and increase the economic efficiency to use resources efficiently.

However, in the recycling process of the lithium ion battery, there is a risk that the metallic lithium abruptly reacts with moisture in the air to explode. A method for recycling the lithium ion batteries is limited to a sol-gel method and an acid leaching method.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of the present disclosure is to provide a method for efficiently recovering nickel, cobalt and lithium carbonate from a waste battery.

In a first aspect of the present disclosure, there is provided a method for recovering nickel and cobalt, the method comprising: a first step of heat-treating lithium nickel cobalt aluminum oxide to produce a mixture; a second step of water-washing the mixture produced in the first step to obtain a residue; and a third step of heat-treating the residue obtained in the second step.

In one embodiment of the first aspect, the lithium nickel cobalt aluminum oxide is obtained from a waste lithium nickel cobalt aluminum oxide battery.

In one embodiment of the first aspect, the first step is performed in a reducing atmosphere.

In one embodiment of the first aspect, the reducing atmosphere in the first step is composed of carbon dioxide, carbon monoxide and a mixture thereof.

In one embodiment of the first aspect, the heat treatment in the first step is performed in a range of about 600 degrees Celsius to 1000 degrees Celsius.

In one embodiment of the first aspect, the heat-treatment in the first step is performed for about 1 to 3 hours.

In one embodiment of the first aspect, the mixture produced in the first step contains lithium carbonate (Li₂CO₃), nickel oxide (NiO), cobalt oxide (CoO) and nickel cobalt oxide (NiCoO).

In one embodiment of the first aspect, the method further comprises, after the washing in the second step, a step of separating the residue

In one embodiment of the first aspect, the residue contains nickel oxide, cobalt oxide and nickel cobalt oxide.

In one embodiment of the first aspect, the heat-treatment in the third step includes primary and secondary heat-treatments performed respectively in first and second reactors connected to each other via a guide line, wherein a gaseous product produced from the primary heat treatment in the first reactor is transferred to the second reactor via the guide line and, then, in the secondary reactor, the secondary heat treatment is performed.

In one embodiment of the first aspect, in the primary heat-treatment, the residue is heat-treated in the first reactor.

In one embodiment of the first aspect, the primary heat treatment is performed in a reducing atmosphere.

In one embodiment of the first aspect, the reducing atmosphere in the primary heat treatment is composed of carbon dioxide, carbon monoxide and a mixture thereof.

In one embodiment of the first aspect, the primary heat treatment is performed in a temperature range of 50 degrees Celsius to 200 degrees Celsius.

In one embodiment of the first aspect, the primary heat treatment is performed at a temperature at which Ni(CO)₄ is produced.

In one embodiment of the first aspect, in the primary heat treatment, a cobalt metal powder, and nickel-containing gas are produced.

In one embodiment of the first aspect, the nickel-containing gas contains Ni(CO)₄.

In one embodiment of the first aspect, the guide line is maintained at a temperature range of about 60 degrees Celsius to 100 degrees Celsius.

In one embodiment of the first aspect, the secondary heat treatment is performed in an atmosphere composed of Ni(CO)₄.

In one embodiment of the first aspect, the secondary heat treatment is performed at a temperature range of about 150 degrees Celsius to 350 degrees Celsius.

In one embodiment of the first aspect, in the secondary heat treatment, a nickel metal powder is produced.

In a first aspect of the present disclosure, there is provided a method for recovering nickel and cobalt, the method comprising: (a) heat-treating a lithium nickel cobalt aluminum oxide in a range of about 600 degrees Celsius to 800 degrees Celsius and for 1 hour to 3 hours in a reducing atmosphere containing carbon dioxide, carbon monoxide and mixtures thereof, to produce a mixture containing lithium carbonate (Li₂CO₃), nickel oxide (NiO), cobalt oxide (CoO) and nickel cobalt oxide (NiCoO); (b) water-washing the mixture to obtain a residue; and (c) heat-treating the residue, wherein the heat-treatment of the residue includes primary and secondary heat-treatments performed respectively in first and second reactors connected to each other via a guide line, wherein the primary heat treatment includes heat-treating the residue at about 50 degrees Celsius to 200 degrees Celsius in the first reactor having a reducing atmosphere containing carbon dioxide, carbon monoxide and a mixture thereof, to produce a cobalt metal powder and a nickel-containing gas from the residue, wherein the nickel-containing gas produced in the primary heat treatment is transferred from the first reactor to the second reactor via the guide line maintained at a temperature of about 70 degrees Celsius to 90 degrees Celsius, wherein in the secondary heat treatment, a heat treatment is performed in the second reactor having an atmosphere of the nickel-containing gas transferred from the first reactor at about 150 degrees Celsius to 350 degrees Celsius, to produce nickel.

The nickel and cobalt recovery method according to the present disclosure is a method for recycling the waste battery. This method is a method for recovering nickel and cobalt metal powders and lithium carbonate from the waste NCA (waste lithium nickel cobalt aluminum oxide) battery. According to the present disclosure, a cost for a waste water treatment and an environmental burden may be lowered compared with the conventional technique. Further, using a relatively simple process, nickel, cobalt and lithium carbonate utilized in various fields may be recovered.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a schematic representation of one embodiment according to the present disclosure.

FIG. 2 shows an apparatus for implementing one embodiment according to the present disclosure.

FIG. 3 shows one embodiment according to the present disclosure.

FIG. 4 to FIG. 8 show results of comparative experiments according to one embodiment according to the present disclosure.

### DETAILED DESCRIPTIONS

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

A nickel and cobalt recovery method according to the present disclosure includes a first step of heat-treating lithium nickel cobalt aluminum oxide; a second step of washing a mixture produced in the first step; and a third step of heat-treating a residue produced in the second step.

In one embodiment, the lithium nickel cobalt aluminum oxide may be a portion of a waste material obtained from a waste lithium ion battery or a waste NCA battery. In accordance with the present disclosure, waste batteries may be recycled. For example, according to the present disclosure, nickel and cobalt metals may be recovered from a waste lithium ion battery.

In one embodiment, the heat-treatment of the first step may be a pyrolysis process.

In one embodiment, the first step may be performed in a reducing atmosphere. For example, the reducing atmosphere at the first step may contain at least one of carbon dioxide, carbon monoxide, and a mixture thereof. For example, the reducing atmosphere may be a reducing atmosphere composed of a mixed gas of carbon dioxide and carbon monoxide. Alternatively, the reducing atmosphere may be a reducing atmosphere composed of only carbon dioxide.

In one embodiment, the heat treatment in the first step may be performed in a range of 600 degrees Celsius to 1000 degrees Celsius. For example, the heat treatment in the first step may be performed in a range of 600 degrees Celsius to 800 degrees Celsius. The heat treatment at the first step may be performed at 700 degrees Celsius, though the present disclosure is not limited thereto. In one embodiment, the heat treatment in the first step may be a pyrolysis process.

In one embodiment, the heat-treatment in the first step may be performed for 1 to 3 hours. For example, the heat treatment may be performed for 3 hours.

In one embodiment, in the first step, a mixture containing lithium carbonate (Li₂CO₃), nickel oxide (NiO), cobalt oxide (CoO) and nickel cobalt oxide (NiCoO) may be produced.

In one example, in the first step, a waste NCA battery powder may be placed inside a reactor. Then, while nitrogen or argon gas may be injected into the reactor at 300 cc/min, a temperature inside the reactor may be increased to 700 degrees Celsius. Thereafter, when the temperature reaches the target temperature (700 degrees Celsius), the pyrolysis (calcination) may be performed for 3 hours while the reducing gas composed of carbon dioxide may be injected into the reactor. In the first step, the mixture containing lithium carbonate, nickel oxide, cobalt oxide and nickel cobalt oxide may be produced. For example, in the first step, the waste NCA battery powder may be pyrolyzed to form the mixture.

In one embodiment, the mixture may contain lithium carbonate, nickel oxide, cobalt oxide and nickel cobalt oxide. For example, the mixture may contain lithium carbonate, nickel oxide and cobalt oxide. In another example, the mixture may contain lithium carbonate and nickel cobalt oxide.

In one embodiment, the washing process in the second step may be to wash the mixture produced in the first step with distilled water. Alternatively, the second step may be to mix the mixture with the distilled water. In one embodiment, the washing process may be performed one to three times, but the present disclosure is not limited thereto. The washing process may be performed for 30 minutes to 120 minutes. For example, the washing process may be performed more than three times for 120 minutes or more. In one embodiment, in the washing process, a 5 to 30 ratio of distilled water based on the mixture may be used. Alternatively, the mixture and water may be mixed such that a ratio of the water based on the mixture is in a range of 5 to 30. For example, the washing process may be to mix the mixture produced in the first step with distilled water so that a portion of the mixture is dissolved in the distilled water.

In one embodiment, a step of separating a residue may be further included in the method after the washing process in the second step. In one embodiment, the residue may contain nickel oxide, cobalt oxide and nickel cobalt oxide. In one embodiment, the residue may be a nickel cobalt oxide. For example, the residue may contain at least one of nickel cobalt oxide, nickel oxide, cobalt oxide, and mixtures thereof.

In one embodiment, after the washing process, the step of separating the residue may be a step of washing the mixture with distilled water and then separating the residue separately. Alternatively, the mixture may be mixed with distilled water, and a solid material (precipitate) and a liquid material may be separated from each other. In one example, since the mixture contains lithium carbonate, nickel oxide, cobalt oxide and nickel cobalt oxide and the lithium carbonate is easily dissolved in water, the lithium carbonate may be easily separated from the nickel oxide, cobalt oxide and nickel cobalt oxide via a simple washing process and a simple separation process. In other words, in the washing step in the second step, and in the step of separating the residue (or precipitate), the residue containing the nickel oxide, the cobalt oxide and the nickel cobalt oxide may be separated from the aqueous solution containing the lithium carbonate.

In one example, lithium carbonate powder may be produced by drying an aqueous solution containing lithium carbonate at 100 degrees Celsius or more for 1 hour or more. For example, an aqueous solution containing the lithium carbonate is injected into the dryer. Then, in the dryer, the aqueous solution is dried at 150 degrees Celsius for 24 hours. As a result, a lithium carbonate powder may be produced. In one embodiment, a vapor distilled using the dryer may be again brought into a liquid state through the condenser, and the liquid state water may then be reused in the washing process. Thus, as the water is reused, the recycling of waste batteries according to the present disclosure may be more efficient in terms of environmental and cost.

In one embodiment, the heat-treatment in the third step may be performed more than once in at least two reactors.

In one embodiment, the heat-treatment in the third step may include a primary heat-treatment and a secondary heat-treatment, which are performed separately in the first and second reactors connected via a guide line. At least a portion of a product from the primary heat treatment formed in the first reactor may be transferred to the second reactor via the guide line. Then, at least a portion of the product from the primary heat treatment may be transferred to the second reactor, and in the second reactor, the secondary heat-treatment may be performed.

In other words, a gaseous material in the product from the primary heat treatment is injected into the second reactor. Then, a reaction in the second reactor may occur by performing the secondary heat-treatment. Alternatively, a portion of the product from the primary heat-treatment may be used as a portion of a reactant in the secondary heat-treatment in the second reactor. For example, the heat-treatment in the third step may include the primary heat-treatment performed first and the secondary heat-treatment performed subsequently. Alternatively, the primary heat treatment and secondary heat treatment may be performed simultaneously. Although the present disclosure is not limited to a following, the third step may be performed in a two-stage reactor, for example, in an apparatus containing a two-stage electric furnace.

In one embodiment, the product from the primary heat treatment may be a mixture of gas and solid. For example, gaseous material in the product from the primary heat treatment may be injected via the guide line into the second reactor for performing the secondary heat-treatment. In other words, the gaseous material generated from the first reactor may be injected into the second reactor via the guide line.

In one embodiment, the primary heat-treatment may be to heat-treat the residue in the first reactor. In other words, the primary heat-treatment may be a process of placing the residue in the first reactor and performing the heat-treatment therein.

In one embodiment, the primary heat treatment may be performed in a reducing atmosphere. In one embodiment, the reducing atmosphere for the primary heat treatment may be composed of carbon dioxide, carbon monoxide and mixtures thereof. For example, the reducing atmosphere for the primary heat treatment may be comprised of carbon monoxide.

In one embodiment, the primary heat treatment may be performed at a temperature range of 50 degrees Celsius to 200 degrees Celsius. For example, in the primary heat-treatment, the residue nickel cobalt oxide may be disposed in the first reactor, and a reaction may then occur at 200 degrees Celsius while the carbon monoxide as the reducing gas is introduced into the first reactor. Alternatively, the residue may be placed in the first reactor, and, then, a reaction may then occur at 80 degrees Celsius while carbon monoxide as a reducing gas may be injected into the reactor.

In one embodiment, the primary heat treatment may be performed at a temperature range where Ni(CO)₄ is generated. For example, the primary heat treatment may be performed via regulating the temperature so that Ni(CO)₄ is generated.

In one embodiment, in the primary heat treatment, a cobalt metal powder and a nickel-containing gas may be produced. In one embodiment, in the first reactor, a reaction: Ni(s)+4CO(g)→Ni(CO)₄(g) may occur. In one embodiment, the nickel-containing gas may contain Ni(CO)₄.

In one embodiment, the nickel-containing gas may be injected into the second reactor from the first reactor via the guide line. For example, Ni(CO)₄ produced in the primary heat treatment in the first reactor may be injected into the second reactor from the first reactor via the guide line.

In one embodiment, the guide line may be maintained in a temperature range of 60 degrees Celsius to 100 degrees Celsius. For example, the guide line may be maintained at 80 degrees Celsius. The Ni(CO)₄ gas generated by the primary heat treatment may be injected into the second reactor via the guide line while maintaining the temperature at 80 degrees Celsius.

In one embodiment, the secondary heat treatment may be performed in an atmosphere containing the Ni(CO)₄. For example, the Ni(CO)₄ may be used as a reactant for the secondary heat-treatment. In one embodiment, in the second reactor, a reaction: Ni(CO)₄(g)→Ni(s)+4CO(g) may occur.

In one embodiment, the secondary heat treatment may be performed at a temperature range of 150 degrees Celsius to 350 degrees Celsius. In one embodiment, in the secondary heat treatment, a nickel metal powder may be produced. For example, the secondary heat-treatment may be performed as follows: the Ni(CO)₄ produced in the primary heat treatment is injected via the guide line maintained at 80 degrees Celsius, into the second reactor, and, then, heat treatment is performed at 180 degrees Celsius, thereby producing the nickel metal powder.

In another aspect of the present disclosure, there is provided a method for recovering nickel and cobalt, the method comprising: (a) heat-treating a lithium nickel cobalt aluminum oxide in a range of about 600 degrees Celsius to 800 degrees Celsius and for 1 hour to 3 hours in a reducing atmosphere containing carbon dioxide, carbon monoxide and mixtures thereof, to produce a mixture containing lithium carbonate (Li₂CO₃), nickel oxide (NiO), cobalt oxide (CoO) and nickel cobalt oxide (NiCoO); (b) water-washing the mixture to obtain a residue; and (c) heat-treating the residue, wherein the heat-treatment of the residue includes primary and secondary heat-treatments performed respectively in first and second reactors connected to each other via a guide line, wherein the primary heat treatment includes heat-treating the residue at about 50 degrees Celsius to 200 degrees Celsius in the first reactor having a reducing atmosphere containing carbon dioxide, carbon monoxide and a mixture thereof, to produce a cobalt metal powder and a nickel-containing gas from the residue, wherein the nickel-containing gas produced in the primary heat treatment is transferred from the first reactor to the second reactor via the guide line maintained at a temperature of about 70 degrees Celsius to 90 degrees Celsius, wherein in the secondary heat treatment, a heat treatment is performed in the second reactor having an atmosphere of the nickel-containing gas transferred from the first reactor at about 150 degrees Celsius to 350 degrees Celsius, to produce nickel.

In one example, a nickel and cobalt recovery method includes (a) heat-treating lithium nickel cobalt aluminum oxide obtained from a waste lithium nickel cobalt aluminum oxide battery in a reducing atmosphere containing carbon dioxide at 700 degrees Celsius for 3 hours, (b) water-washing a mixture containing lithium carbonate, nickel oxide, cobalt oxide and nickel cobalt oxide produced in the step (a); and (c) heat-treating a residue obtained in the step (b). The heat-treatment of the residue includes primary and secondary heat-treatments performed respectively in first and second reactors connected to each other via a guide line. The primary heat treatment is performed at 80 degrees Celsius in a reducing atmosphere containing carbon monoxide to produce a cobalt metal powder and Ni(CO)₄ gas from the residue. The Ni(CO)₄ gas produced in the primary heat treatment is injected into the second reactor from the first reactor via the guide line maintained at 80 degrees Celsius. The secondary heat treatment is performed at a temperature of 180 degrees Celsius in an atmosphere of the Ni(CO)₄ from the first reactor to produce a nickel metal powder.

In another example of the nickel and cobalt recovery method, before the heat-treatment in the step (c), the residue is charged to the reactor and the residue is reduced using hydrogen gas. In other words, after the step (b), the residue may be reduced using hydrogen, and then, in the step (c), the heat-treatment of the residue may be performed. In one embodiment, the hydrogen reduction process may be performed in a separate reactor. In one example, in the first reactor, the hydrogen reduction process may be performed, and then the primary heat treatment may be performed.

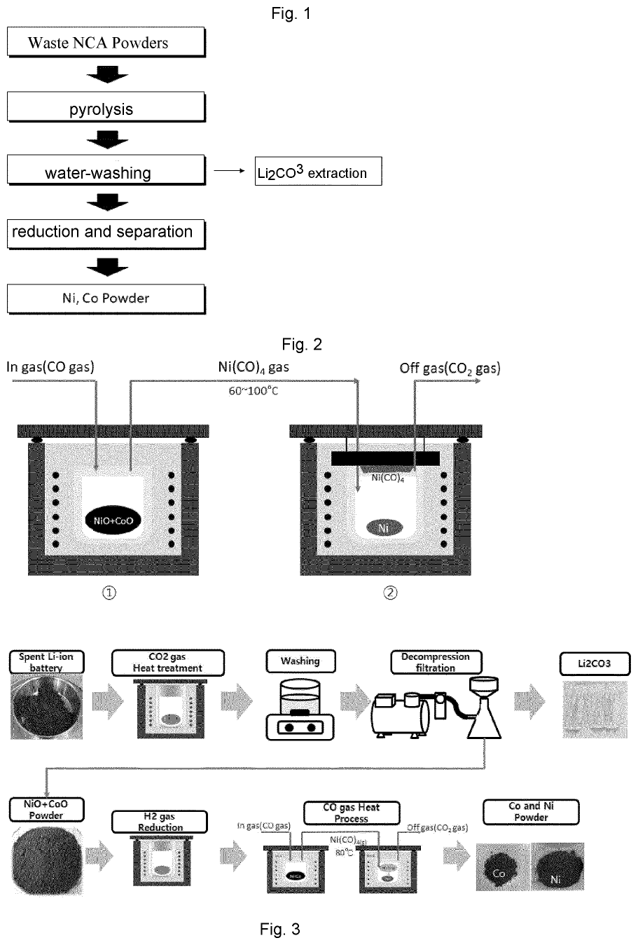

FIG. 1 is a schematic representation of one embodiment according to the present disclosure. In FIG. 1, waste NCA powders were pyrolyzed. Then, the lithium carbonate was extracted first via a washing process. The lithium carbonate was removed, and remaining materials was subjected to a reducing and separating process. Thus, nickel and cobalt metal powders were produced.

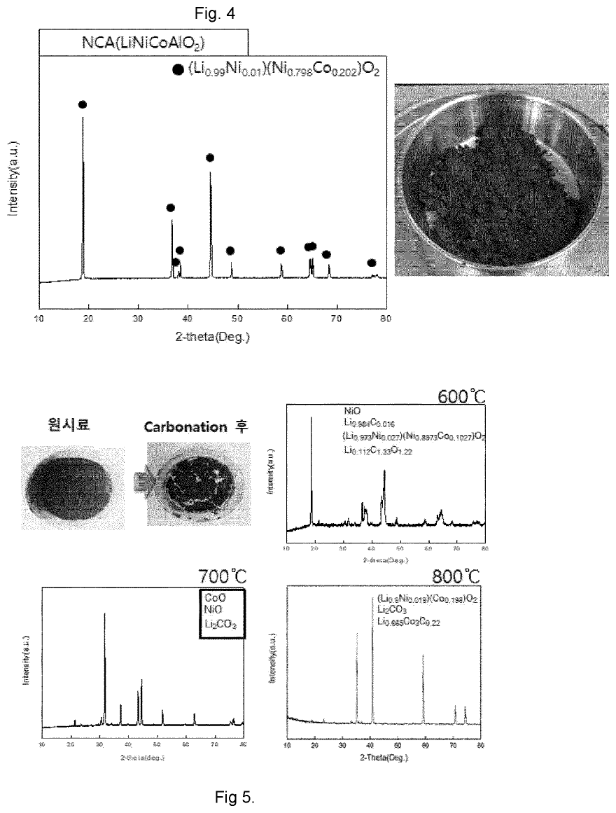

FIG. 2 shows an apparatus for implementing one embodiment according to the present disclosure. The nickel and cobalt recovery method according to the present disclosure may be performed using a two-stage electric furnace as shown in FIG. 2. Referring to FIG. 2, the two-stage electric furnace may include a first reactor, a second reactor and a guide line connecting the first reactor and the second reactor. In one embodiment, the temperatures of the first reactor, the second reactor, and the guide line may be independently adjusted.

### Present Example 1

A present example according to the present disclosure as shown in FIG. 1 is shown below.

First, a waste material containing lithium nickel cobalt aluminum oxide extracted from the waste NCA battery was placed inside the reactor. Then, the reactor was heated to a range of 600 degrees Celsius to 1000 degrees Celsius while introducing nitrogen or argon gas into the reactor at 300 cc/min. When the target temperature is reached, the pyrolysis was carried out for 1 hour to 3 hours while injecting carbon dioxide or and a mixed gas of carbon monoxide and carbon dioxide as the reducing gas into the reactor. Thus, a mixture containing lithium carbonate, nickel oxide and cobalt oxide was produced. Then, a washing process of mixing the above mixture into water was repeated three times. As a result, an aqueous solution (liquid material) containing lithium carbonate and the residue (solid material) were separated from each other. At this time, the separated aqueous solution was separately dried to obtain a lithium carbonate powder. The residue was then placed in a first reactor. The residue was heat-treated at 200 degrees Celsius in a carbon monoxide atmosphere. At this time, the cobalt metal powder and Ni(CO)₄ are generated in the first reactor. The gaseous Ni(CO)₄ was injected into the second reactor via a guide line maintained at 60 to 100 degrees Celsius. The Ni(CO) 4 injected into the second reactor was heat-treated in a range of 300 degrees Celsius to 350 degrees Celsius. As a result, a nickel metal powder was produced.

### Present Example 2

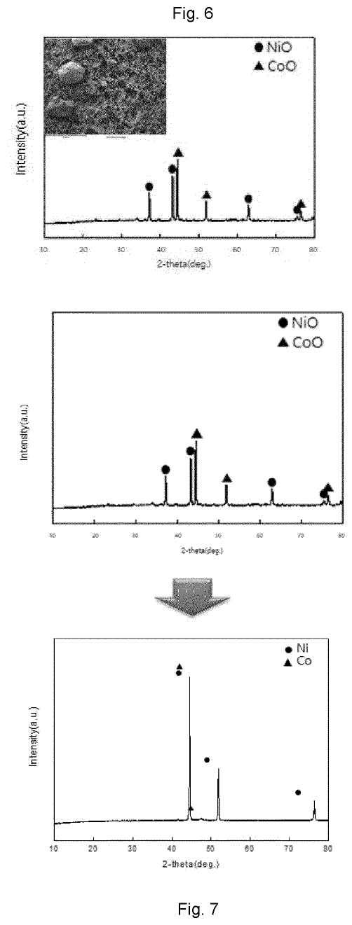

As shown in FIG. 3, one embodiment according to the present disclosure is shown below. FIG. 3 shows one embodiment according to the present disclosure.

First, the used lithium ion battery (alternatively, the waste material from the used lithium ion battery, or the waste material containing lithium nickel cobalt aluminum oxide) is put into the reactor. The interior of the reactor was filled with a carbon dioxide gas atmosphere. The heat treatment was carried out for 3 hours at 700 degrees Celsius (Present example is performed at 600 degrees Celsius and 800 degrees Celsius respectively). The heat-treated product was then washed with water. Subsequently, decompression filtration was used to separate the liquid material containing lithium carbonate (Li₂CO₃) and the solid material containing at least one of the nickel oxide, cobalt oxide, and nickel cobalt oxide, that is, the residue from each other. Next, the residue was placed in the reactor and reduced in a hydrogen gas atmosphere. Then, the inside of the first reactor is filled with a carbon monoxide atmosphere. Heat treatment was performed at 80 degrees Celsius to produce cobalt metal powder and Ni(CO)₄ gas. The generated Ni(CO)₄ gas was injected into the second reactor via the guide line while maintaining the temperature of the gas at 80 degrees Celsius. As a result, the inside of the second reactor was filled with the Ni(CO)₄ gas atmosphere. Thereafter, nickel metal powder was produced by heat-treating the residue in the second reactor at 180 degrees Celsius.

Analysis

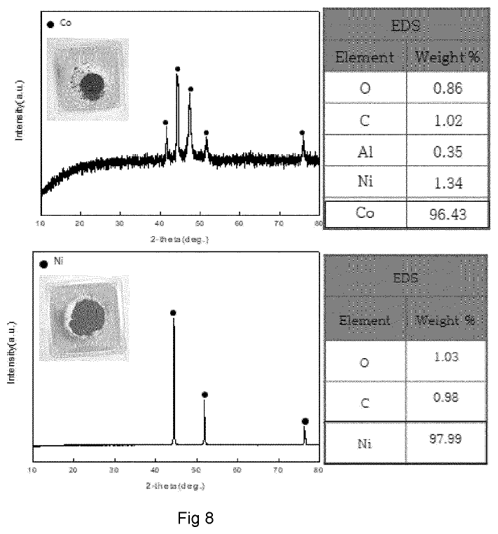

FIG. 4 to FIG. 8 show results of comparative experiments according to one embodiment according to the present disclosure. Referring to FIG. 4 to FIG. 8, the results are indicated below.

FIG. 4 shows an analysis of the nickel cobalt aluminum oxide complex before performing the nickel and cobalt recovery method according to one embodiment. From the analysis results, as shown in FIG. 4, the peak of nickel cobalt aluminum oxide was confirmed. From the results of the EDS analysis, it was confirmed that aluminum (Al) has 0.60 wt %, oxygen (O) has 27.32 wt %, nickel (Ni) has 62.02 wt % and cobalt (Co) has 10.06 wt %. From the result of ICP analysis, it was confirmed that 7.00 wt % of lithium (Li) was contained.

According to one embodiment, lithium nickel cobalt aluminum oxide was heat-treated at 600 degrees Celsius, 700 degrees Celsius, and 800 degrees Celsius for 3 hours. The results of carbonation are shown in FIG. 5. Further, FIG. 5 compares states before and after the carbonation. Comparing the difference based on the temperatures, it may be seen that at temperatures above 600 degrees Celsius, lithium nickel cobalt aluminum oxide reacts with carbon dioxide gas, resulting in a phase change. In particular, at 700 degrees Celsius, complete phase separation between lithium carbonate and nickel oxide and cobalt oxide was observed. Therefore, heat-treatment at the 700 degrees Celsius may be most efficient for waste battery recycling according to the present disclosure.

FIG. 6 shows XRD and SEM analysis results of the solid material separated after the second step according to the present disclosure, that is, the residue. From these results, it was confirmed that the aluminum content was 0.76 wt %, the carbon content was 1.23 wt %, the oxygen content was 30.86 wt %, the nickel content was 10.36 wt %, and the cobalt content was 56.79 wt %. As a result, nickel oxide and cobalt oxide were confirmed. The separated liquid material separated after the second step was analyzed, and the analysis results are shown in following Table 1 and Table 2.

TABLE 1

| Time(h) | Li(ppm) |
|---|---|
| 1 | 2343 |
| 2 | 2338 |
| 3 | 2377 |

TABLE 2

| Ratio | Li(ppm) |
|---|---|
| 1:5 | 2343 |
| 1:10 | 2339 |
| 1:15 | 2349 |

The Table 1 shows the lithium content according to the water leaching time. The Table 2 shows the lithium content according to the ratio of distilled water. The ratio of liquid phase material:distilled water was adjusted to 1:30 and water leaching was carried out for 1 hour. From this experiment, it was confirmed that the content of lithium was 2348 ppm.

FIG. 7 compares the hydrogen reduction results in accordance with one embodiment. An upper graph is the result of analysis of the residue before the hydrogen reduction, and a lower graph is the result of the analysis of the residue after the hydrogen reduction. Via the hydrogen reduction, the contents of nickel oxide to cobalt oxide were higher. When the hydrogen reduction step is further included before the third step according to the present disclosure, the yield and purity of nickel and cobalt metal powders may be further improved. Alternatively, the hydrogen reduction step may affect the heat-treatment time or temperature range in the heat-treatment process in the third step according to the present disclosure.

FIG. 8 shows the results of the analysis of the products obtained from the first and second reactors after performing the third step according to one embodiment according to the present disclosure. An upper graph in FIG. 8 shows the analysis of the solid material obtained after the heat-treatment in the first reactor. From the results of the EDS analysis, it was confirmed that the oxygen content was 0.86 wt %, the carbon content was 1.02 wt %, the aluminum content was 0.35 wt %, the nickel content was 1.34 wt %, and the cobalt content was 96.43 wt %. It may be confirmed that the cobalt metal powder is produced by the primary heat treatment performed in the first reactor. A lower graph in FIG. 8 shows the analytical results of the solid material obtained after the reaction in the second reactor. From the results of the EDS analysis, it may be confirmed that the nickel metal powder was produced with an oxygen content of 1.03 wt %, a carbon content of 0.98 wt %, and a nickel content of 97.99 wt %. As a result, according to the present disclosure, it could be confirmed that cobalt metal powder and nickel metal powder were formed.

According to the present disclosure, the nickel and cobalt recovery process can be achieved, which is safer, simpler, more environmentally and cost-effectively, since it does not involve a complex and dangerous conventional wet process using acids.

Previously, there was absent a lot of recycling techniques for waste NCA batteries. Further, there are not many techniques to recover all of lithium carbonate, nickel and cobalt at the same time. Thus, the recycling method according to the present disclosure, which may recycle all of the lithium carbonate, nickel and cobalt metal by recycling the waste NCA battery, may be used in various fields.

While the present disclosure has been described with reference to preferred embodiments, those skilled in the art will appreciate that the present disclosure may be variously modified and changed without departing from the spirit and scope of the present disclosure set forth in the following claims.

What is claimed is:

1. A method for recovering nickel and cobalt, the method comprising:
a first step of heat-treating lithium nickel cobalt aluminum oxide to produce a mixture;
a second step of water-washing the mixture produced in the first step to obtain a residue; and
a third step of heat-treating the residue obtained in the second step.

2. The method of claim 1, wherein the lithium nickel cobalt aluminum oxide is obtained from a waste lithium nickel cobalt aluminum oxide battery.

3. The method of claim 2, wherein the first step is performed in a reducing atmosphere.

4. The method of claim 3, wherein the reducing atmosphere in the first step is composed of carbon dioxide, carbon monoxide and a mixture thereof.

5. The method of claim 4, wherein the heat treatment in the first step is performed in a range of about 600 degrees Celsius to 1000 degrees Celsius.

6. The method of claim 5, wherein the heat-treatment in the first step is performed for about 1 to 3 hours.

7. The method of claim 6, wherein the mixture produced in the first step contains lithium carbonate (Li₂CO₃), nickel oxide (NiO), cobalt oxide (CoO) and nickel cobalt oxide (NiCoO).

8. The method of claim 2, wherein the method further comprises, after the washing in the second step, a step of separating the residue.

9. The method of claim 8, wherein the residue contains nickel oxide, cobalt oxide and nickel cobalt oxide.

10. The method of claim 1, wherein the heat-treatment in the third step includes primary and secondary heat-treatments performed respectively in first and second reactors connected to each other via a guide line,
wherein a gaseous product produced from the primary heat treatment in the first reactor is transferred to the second reactor via the guide line and, then, in the secondary reactor, the secondary heat treatment is performed.

11. The method of claim 10, wherein in the primary heat-treatment, the residue is heat-treated in the first reactor.

12. The method of claim 11, wherein the primary heat treatment is performed in a reducing atmosphere.

13. The method of claim 12, wherein the reducing atmosphere in the primary heat treatment is composed of carbon dioxide, carbon monoxide and a mixture thereof.

14. The method of claim 13, wherein the primary heat treatment is performed in a temperature range of 50 degrees Celsius to 200 degrees Celsius.

15. The method of claim 13, wherein the primary heat treatment is performed at a temperature at which Ni(CO)₄ is produced.

16. The method of claim 14, wherein in the primary heat treatment, a cobalt metal powder, and nickel-containing gas are produced.

17. The method of claim 16, wherein the nickel-containing gas contains Ni(CO)₄.

18. The method of claim 17, wherein the guide line is maintained at a temperature range of about 60 degrees Celsius to 100 degrees Celsius.

19. The method of claim 10, wherein the secondary heat treatment is performed in an atmosphere composed of Ni(CO)₄.

20. The method of claim 19, wherein the secondary heat treatment is performed at a temperature range of about 150 degrees Celsius to 350 degrees Celsius.

21. The method of claim 20, wherein in the secondary heat treatment, a nickel metal powder is produced.

22. A method for recovering nickel and cobalt, the method comprising:
(a) heat-treating a lithium nickel cobalt aluminum oxide in a range of about 600 degrees Celsius to 800 degrees Celsius and for 1 hour to 3 hours in a reducing atmosphere containing carbon dioxide, carbon monoxide and mixtures thereof, to produce a mixture containing lithium carbonate (Li₂CO₃), nickel oxide (NiO), cobalt oxide (CoO) and nickel cobalt oxide (NiCoO);
(b) water-washing the mixture to obtain a residue; and
(c) heat-treating the residue,
wherein the heat-treatment of the residue includes primary and secondary heat-treatments performed respectively in first and second reactors connected to each other via a guide line,
wherein the primary heat treatment includes heat-treating the residue at about 50 degrees Celsius to 200 degrees Celsius in the first reactor having a reducing atmosphere containing carbon dioxide, carbon monoxide and a mixture thereof, to produce a cobalt metal powder and a nickel-containing gas from the residue,
wherein the nickel-containing gas produced in the primary heat treatment is transferred from the first reactor to the second reactor via the guide line maintained at a temperature of about 70 degrees Celsius to 90 degrees Celsius,
wherein in the secondary heat treatment, a heat treatment is performed in the second reactor having an atmosphere of the nickel-containing gas transferred from the first reactor at about 150 degrees Celsius to 350 degrees Celsius, to produce nickel.
